(19) United States
(12) Patent Application Publication
(10) Pub. No.: US 2025/0300776 A1
(43) Pub. Date: Sep. 25, 2025

(54) EFFICIENT REFERENCE SIGNALS CONFIGURATION FOR MULTI-USER UPLINK TRANSMISSIONS

(71) Applicant: Cohere Technologies, Inc., San Jose, CA (US)

(72) Inventor: Shachar Kons, San Jose, CA (US)

(73) Assignee: Cohere Technologies, Inc., San Jose, CA (US)

(21) Appl. No.: 18/861,567

(22) PCT Filed: Jun. 23, 2023
(86) PCT No.: PCT/US2023/026165

§ 371 Date: Oct. 29, 2024

Related U.S. Application Data
(60) Provisional application No. 63/366,869, filed on Jun. 23, 2022.

(51) Int. Cl. H04L 5/00; H04W 72/1263; H04W 72/232

(52) U.S. Cl. CPC H04L 5/0023; H04W 72/1263; H04W 72/232

(57) ABSTRACT

A method of wireless communication performed by a base station includes grouping a plurality of wireless devices associated with a coverage area of the base station into multiple spatial groups, and configuring the wireless devices in each spatial group to use overlapping time-frequency transmission resources for uplink (UL) data transmissions to the base station. The method also includes scheduling, on a same set of time-frequency transmission resources, demodulation reference signal (DMRS) transmissions by the wireless devices in a respective spatial group of the multiple spatial groups. In various aspects, the multiple spatial groups are determined based on respective estimated angles of arrival of the plurality of wireless devices associated with the coverage area of the base station. In some instances, each of the wireless devices in the respective spatial group uses the same antenna ports as the other wireless devices in the respective spatial group for the DMRS transmissions.

### CROSS-REFERENCE TO RELATED APPLICATION

This Patent Application claims priority to U.S. Patent Provisional Application No. 63/366,869 entitled “EFFICIENT REFERENCE SIGNALS CONFIGURATION FOR MULTI-USER UPLINK TRANSMISSIONS” and filed on Jun. 23, 2022, which is assigned to the assignee hereof. The disclosures of all prior Applications are considered part of and are incorporated by reference in this Patent Application.

### TECHNICAL FIELD

The present document relates to wireless communication.

### BACKGROUND

Due to an explosive growth in the number of wireless user devices and the amount of wireless data that these devices can generate or consume, current wireless communication networks are fast running out of bandwidth to accommodate such a high growth in data traffic and provide high quality of service to users.

Various efforts are underway in the telecommunication industry to come up with next generation of wireless technologies that can keep up with the demand on performance of wireless devices and networks. Many of those activities involve situations in which a large number of user devices may be served by a network.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method for wireless communication. In various implementations, the method may include grouping a plurality of wireless devices associated with a coverage area of the base station into multiple spatial groups, configuring the wireless devices in each spatial group to use overlapping time-frequency transmission resources for uplink (UL) data transmissions to the base station, and scheduling, on a same set of time-frequency transmission resources, demodulation reference signal (DMRS) transmissions by the wireless devices in a respective spatial group of the multiple spatial groups. In various aspects, the multiple spatial groups are determined based on respective estimated angles of arrival of the plurality of wireless devices associated with the coverage area of the base station. In some instances, the method may also include transmitting a downlink control information (DCI) signal having a pre-defined format that indicates the scheduling of the DMRS transmissions by the wireless devices of the respective spatial group. In some aspects, the pre-defined format of the DCI signal is DCI format_0_1, and the wireless devices in the respective spatial group are configured with the same antenna ports value.

In some implementations, the RAN is a fifth-generation new radio (5G NR) RAN. In some instances, the base station schedules the transmission of DMRS configuration type-1 frames when the number of UL layers available in the base station's coverage area is greater than 6. In other instances, the base station schedules the transmission of DMRS configuration type-2 frames when the number of UL layers available in the base station's coverage area is greater than 12. In some instances, each of the wireless devices in the respective spatial group uses the same antenna ports as the other wireless devices in the respective spatial group for the DMRS transmissions. In some aspects, the method may also include avoiding scheduling zero power transmissions on the same set of time-frequency resources. In some aspects, scheduling the DMRS transmissions may include ensuring that all time-frequency resources not allocated for DMRS transmissions from one wireless device in the respective spatial group are not allocated for DMRS transmissions from the other wireless devices in the respective spatial group. In other aspects, scheduling the DMRS transmissions may include not allocating zero-power time-frequency resources for wireless devices in the respective spatial group.

In other implementations, the RAN may be a Long-Term Evolution (LTE) RAN. In some instances, the base station configures wireless devices associated with the coverage area to use more than 8 transmission layers per spatial group. In other instances, the method may include applying the same cyclic shift to DMRS transmissions associated with the wireless devices in the respective spatial group when there is more than one transmission layer available. In some other instances, the method may include configuring the wireless devices associated with the coverage area of the base station to use up to M different values of cyclic shifts for the DMRS transmissions and to use up to N uplink transmission layers for the DMRS transmissions, where N and M are positive integers and N is greater than M.

Another innovative aspect of the subject matter described in this disclosure can be implemented as a base station for wireless communication. The base station includes one or more processors coupled to a memory. The memory stores instructions that, when executed by the one or more processors, causes the base station to perform one or more operations. In various implementations, the one or more operations may include grouping a plurality of wireless devices associated with a coverage area of the base station into multiple spatial groups, configuring the wireless devices in each spatial group to use overlapping time-frequency transmission resources for uplink (UL) data transmissions to the base station, and scheduling, on a same set of time-frequency transmission resources, demodulation reference signal (DMRS) transmissions by the wireless devices in a respective spatial group of the multiple spatial groups. In various aspects, the multiple spatial groups are determined based on respective estimated angles of arrival of the plurality of wireless devices associated with the coverage area of the base station. In some instances, the operations may also include transmitting a downlink control information (DCI) signal having a pre-defined format that indicates the scheduling of the DMRS transmissions by the wireless devices of the respective spatial group. In some aspects, the pre-defined format of the DCI signal is DCI format_0_1, and the wireless devices in the respective spatial group are configured with the same antenna ports value.

In some implementations, the RAN is a fifth-generation new radio (5G NR) RAN. In some instances, the base station schedules the transmission of DMRS configuration type-1 frames when the number of UL layers available in the base station's coverage area is greater than 6. In other instances, the base station schedules the transmission of DMRS configuration type-2 frames when the number of UL layers available in the base station's coverage area is greater than 12. In some instances, each of the wireless devices in the respective spatial group uses the same antenna ports as the other wireless devices in the respective spatial group for the DMRS transmissions. In some aspects, scheduling the DMRS transmissions may include ensuring that all time-frequency resources not allocated for DMRS transmissions from one wireless device in the respective spatial group are not allocated for DMRS transmissions from the other wireless devices in the respective spatial group. In other aspects, scheduling the DMRS transmissions may include not allocating zero-power time-frequency resources for wireless devices in the respective spatial group.

In other implementations, the RAN may be a Long-Term Evolution (LTE) RAN. In some instances, the base station configures wireless devices associated with the coverage area to use more than 8 transmission layers per spatial group. In some aspects, execution of the instructions for scheduling the DMRS transmissions may cause the base station to apply the same cyclic shift to DMRS transmissions associated with the wireless devices in the respective spatial group when there is more than one transmission layer available. In other aspects, execution of the instructions for scheduling the DMRS transmissions may cause the base station to configure the wireless devices associated with the coverage area of the base station to use up to M different values of cyclic shifts for the DMRS transmissions and to use up to N uplink transmission layers for the DMRS transmissions, where N and M are positive integers and N is greater than M.

### DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows a diagram illustrating an example wireless communications system.

FIG. 2A shows an example of a first 5G NR frame.

FIG. 2B shows an example of a second 5G NR frame.

FIG. 2C shows example downlink (DL) channels within a 5G NR slot.

FIG. 2D shows example uplink (UL) channels within a 5G NR slot.

FIG. 3 shows a diagram illustrating an example base station and user equipment (UE) in a radio access network.

FIG. 4 shows an example signal exchange between a base station and two UEs.

FIG. 5 depicts an uplink resource allocation example for an UL multiuser multi-input-multi-output (MU-MIMO) device.

FIG. 6 depicts an UL resource allocation example for a beamforming receiver.

FIGS. 7 and 8 show flowcharts depicting example operations for wireless communication.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. Aspects of the present disclosure can be implemented in any device, system or network that is capable of transmitting and receiving radio frequency (RF) signals according to one or more of the Long Term Evolution (LTE), 3G, 4G or fifth-generation new radio (5G NR) standards promulgated by the 3rd Generation Partnership Project (3GPP), the Institute of Electrical and Electronics Engineers (IEEE) 802.11 standards, the IEEE 802.15 standards, or the Bluetooth® standards as defined by the Bluetooth Special Interest Group (SIG), among others. Aspects of the present disclosure can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. Aspects of the present disclosure can also be implemented using other wireless communication protocols or RF signals suitable for use in one or more of a wireless wide area network (WWAN), a wireless personal area network (WPAN), a wireless local area network (WLAN), an internet of things (IOT) network, or for vehicle-based communications (V2X) such as those used in vehicle-to-vehicle (V2V) networks.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The wireless or time-variant nature of wireless communication channels poses several challenges in designing a transmission protocol suitable for wireless communication scenarios. These days, users expect their wireless devices to work everywhere and in a variety of mobile or stationary situations. Specifically, the relative movement of transmitters and receivers with respect to each other may cause signal distortions such as varying channel delay, Doppler and/or angular spread, signal degradation due to ground clutter, sea clutter, and so on. Another example of signal degradation is flat fading in which an entire wireless channel occupied by a transmission signal experiences fading or attenuation that may be relatively constant across the channel. In practice, a transmission scheme may need to fit within a certain link budget, maximum power constraint, or linearity of electronics used for transmitting or receiving signals.

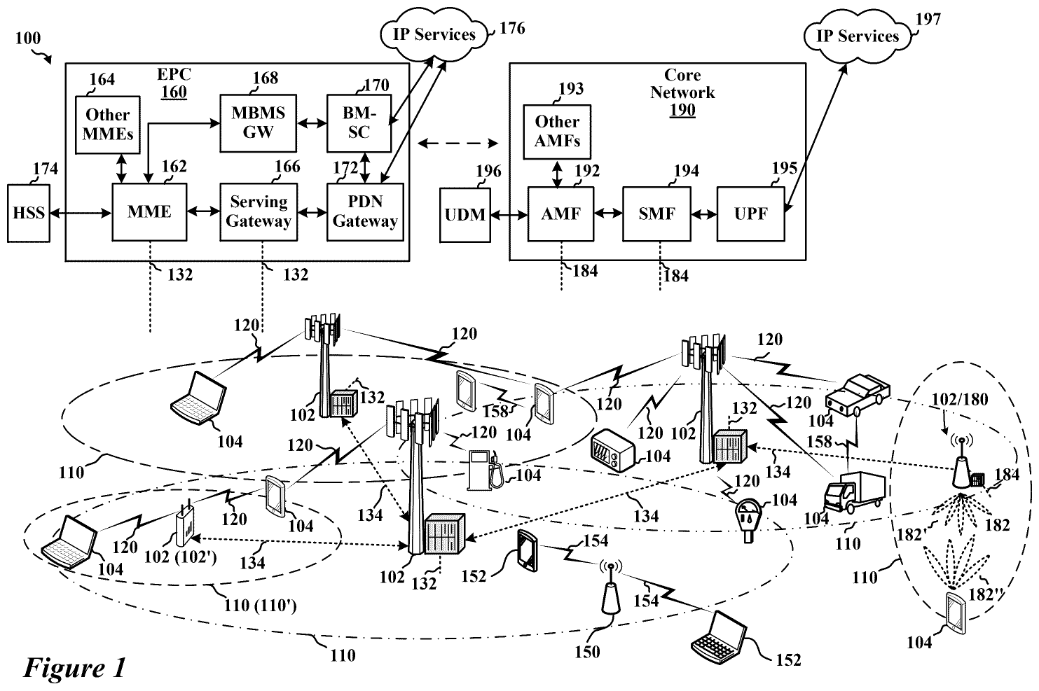

FIG. 1 shows a block diagram of an example wireless communications system 100. The wireless communications system 100, which may be a Fifth Generation (5G) New Radio (NR) radio access network (5G NR-RAN), includes base stations 102, UEs 104, an Evolved Packet Core (EPC) 160, and another core network 190. The base stations 102 may include macrocells (high power cellular base station) or small cells (low power cellular base station). The macrocells include base stations, and the small cells include femtocells, picocells, and microcells.

The base stations 102 configured for 4G LTE (also referred to as Evolved Universal Mobile Telecommunications System (UMTS) Terrestrial Radio Access Network (E-UTRAN)) may interface with the EPC 160 through backhaul links 132 via respective S1 interfaces, and the base stations 102 configured for 5G NR may interface with the core network 190 through backhaul links 184. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or the core network 190) with each other over backhaul links 134 (such as using their respective X2 interfaces). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity.

The communication links may be through one or more carriers. The base stations 102 and UEs 104 may use spectrum up to Y MHz (such as 5 MHz, 10 MHz, 15 MHz, 20 MHz, 100 MHz, 400 MHz, etc.) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 2.4 GHz unlicensed frequency spectrum, a 5 GHz unlicensed frequency spectrum, or both. When communicating in an unlicensed frequency spectrum, the STAs 152 and the AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as a macro base station), may include an eNB, gNodeB (gNB), or another type of base station. Some base stations, such as gNB 180, may operate in a traditional sub 6 GHz spectrum, in millimeter wave (mmW) frequencies, or near mmW frequencies in communication with the UE 104. When the gNB 180 operates in mmW or near mmW frequencies, the gNB 180 may be referred to as a millimeter wave or mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (such as between 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182′. The UE 104 also may transmit a beamformed signal to the base station 180 in one or more transmit directions. The base station 180 may receive the beamformed signal from the UE 104 in one or more receive directions. The base station 180 and UE 104 may perform beam training to determine the best receive and transmit directions for each of the base station 180 and UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting MBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station also may be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or the core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as an MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

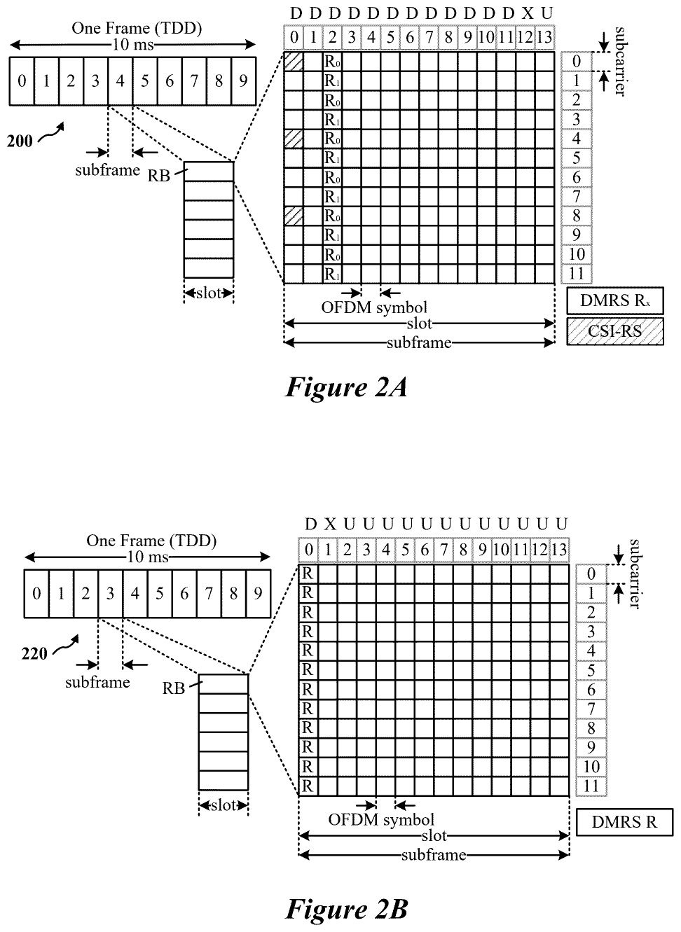

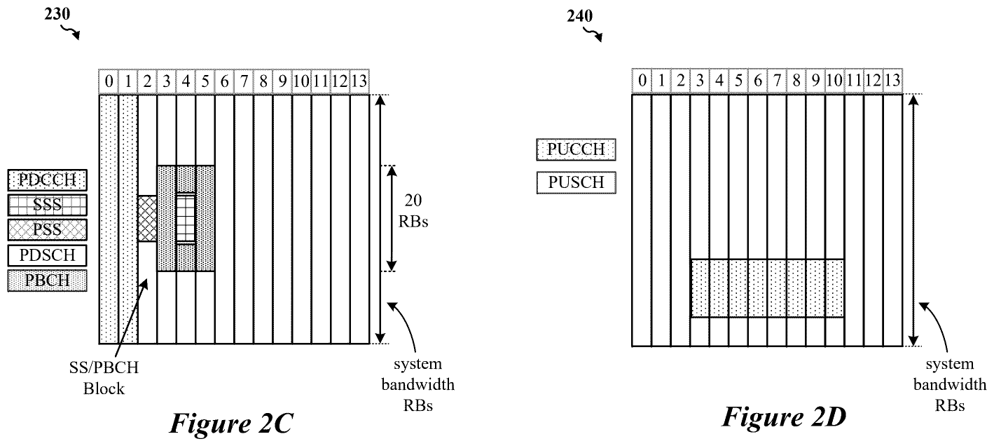

FIG. 2A shows an example of a first slot 200 within a 5G NR frame structure. FIG. 2B shows an example of a second slot 220 within a 5G NR frame structure. FIG. 2C shows an example of DL channels 230 within a 5G NR slot. FIG. 2D shows an example of UL channels 240 within a 5G NR slot. In some cases, the 5G NR frame structure may be FDD in which, for a particular set of subcarriers (carrier system bandwidth), slots within the set of subcarriers are dedicated for either DL or UL transmissions. In other cases, the 5G NR frame structure may be TDD in which, for a particular set of subcarriers (carrier system bandwidth), slots within the set of subcarriers are dedicated for both DL and UL transmissions. In the examples shown in FIGS. 2A and 2B, the 5G NR frame structure is based on TDD, with slot 4 configured with slot format 28 (with mostly DL), where D indicates DL, U indicates UL, and X indicates that the slot is flexible for use between DL and UL, and with slot 3 configured with slot format 34 (with mostly UL). While slots 3 and 4 are shown with slot formats 34 and 28, respectively, any particular slot may be configured with any of the various available slot formats 0-61. Slot formats 0 and 1 are all DL and all UL, respectively. Other slot formats 2-61 include a mix of DL, UL, and flexible symbols. UEs may be configured with the slot format, either dynamically through downlink control information (DCI) or semi-statically through radio resource control (RRC) signaling by a slot format indicator (SFI). The configured slot format also may apply to a 5G NR frame structure that is based on FDD.

Other wireless communication technologies may have a different frame structure or different channels. A frame may be divided into a number of equally sized subframes. For example, a frame having a duration of 10 microseconds (ms) may be divided into 10 equally sized subframes each having a duration of 1 ms. Each subframe may include one or more time slots. Each slot may include 7 or 14 symbols, depending on the slot configuration. For slot configuration 0, each slot may include 14 symbols, and for slot configuration 1, each slot may include 7 symbols. Subframes also may include mini-slots, which may include 7, 4, or 2 symbols. The symbols on DL may be cyclic prefix (CP) OFDM (CP-OFDM) symbols. The symbols on UL may be CP-OFDM symbols (such as for high throughput scenarios) or discrete Fourier transform (DFT) spread OFDM (DFT-s-OFDM) symbols (also referred to as single carrier frequency-division multiple access (SC-FDMA) symbols) (such as for power limited scenarios).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols per slot and 2μ slots per subframe. The subcarrier spacing and symbol length/duration are a function of the numerology. The subcarrier spacing may be equal to 2\hat{ }μ*15 kHz, where u is the numerology 0 to 5. As such, the numerology μ=0 has a subcarrier spacing of 15 kHz, and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 microseconds (μs).

In some implementations, a resource element (RE) may consist of one symbol period and one subcarrier (such as a 15 kHz frequency range). A resource block (RB), also referred to as a physical resource block (PRB), typically spans across 14 OFDM symbols in the time domain and extend across 12 consecutive subcarriers in the frequency domain. Thus, an RB may include 160 REs associated with a particular slot of a radio subframe. The number of bits carried by each RE depends on the modulation scheme.

As illustrated in FIG. 2A, some of the REs carry a reference signal (RS) for the UE. In some configurations, one or more REs may carry a demodulation reference signal (DM-RS) (indicated as Rx for one particular configuration, where 100 x is the port number, but other DM-RS configurations are possible). In some configurations, one or more REs may carry a channel state information reference signal (CSI-RS) for channel measurement at the UE. The REs also may include a beam measurement reference signal (BRS), a beam refinement reference signal (BRRS), and a phase tracking reference signal (PT-RS).

As illustrated in FIG. 2B, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2C illustrates an example of various DL channels 230 within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe or symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

FIG. 2D illustrates an example of various UL channels 240 within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

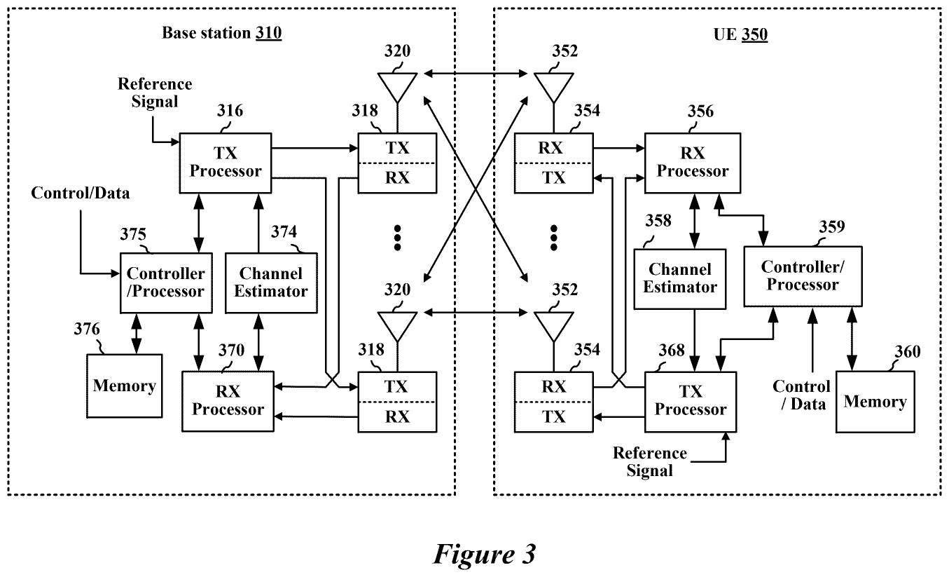

FIG. 3 shows a block diagram of an example base station 310 and UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as the MIB and SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (such as a pilot signal) in the time or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as the MIB and SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations. Information to be wirelessly communicated (such as for LTE or NR based communications) is encoded and mapped, at the PHY layer, to one or more wireless channels for transmission.

In the example of FIG. 3, each antenna 352 of the UE 350 is coupled to a respective transmitter 354TX. However, in some other implementations, the UE 350 may include fewer transmitters (or transmit chains) than receive (RX) antennas. Although not shown for simplicity, each transmitter may be coupled to a respective power amplifier (PA) which amplifies the signal to be transmitted. The combination of a transmitter and a PA may be referred to herein as a “transmit chain” or “TX chain.” To save on cost or die area, the same PA may be reused to transmit signals over multiple RX antennas. In other words, one or more TX chains of a UE may be selectively coupled to multiple RX antennas ports.

In frequency division multiplexing (FDM) networks, transmissions to and from a base station may occupy different frequency bands, and each frequency band may occupy a continuous portion of the wireless spectrum or a discontinuous portion of the wireless spectrum). In time division multiplexing (TDM) networks, transmissions to and from a base station occupy the same frequency band but are separated in time domain using a TDM mechanism such as time slot-based transmissions.

As discussed, the PUSCH carries data symbols and demodulation reference signals (DMRS) that can be used for estimating the channel response and equalizing the data symbols at the base station's receiver. Typically, when UL MU-MIMO transmissions are scheduled for multiple users, a minimum mean square error (MMSE) equalizer is used to jointly equalize and separate the users from one another. Since the effectiveness of the MMSE equalizer is based on accurate channel estimates, users scheduled for concurrent UL transmissions on the same time and frequency resources typically maintain their respective DMRS transmissions orthogonal to each other, for example, to provide spatial diversity between the users. In LTE, DMRS transmissions from multiple UEs may be concurrently transmitted using a Zadoff-Chu sequence over the entire frequency resources, for example, such that each UE applies a different cyclic shift to its respective DMRS transmission, which in turn causes different UEs to have channel responses with different delays. In a 5G NR access network, different time-frequency resources can be allocated to different UEs for UL DMRS transmissions and can be limited to zero-power transmissions to avoid interference between the UEs.

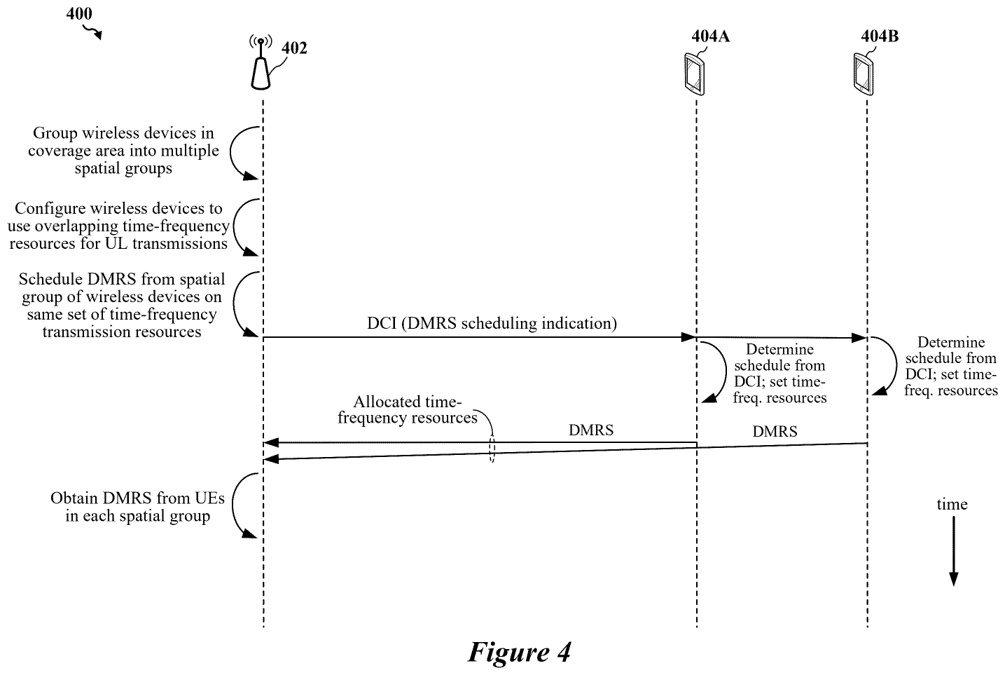

FIG. 4 shows an example wireless communication 400 between a base station 402 and two UEs 404A and 404B in a radio access network (RAN). The base station 402 can be any suitable base station such as the base station 102 of FIG. 1 or the base station 310 of FIG. 3, and the UEs 404A and 404B can be any suitable user wireless devices such as the UEs 104 of FIG. 1 or the UE 350 of FIG. 3. Although the example communication 400 shows only one base station 402 and two UEs 404A-404B, in other implementations, more than one base station and/or more than two UEs can participate in the wireless communication 400.

In various implementations, the base station 402 can use DMRS transmissions from UEs 404A-404B (and other UEs in the coverage area of base station 402, not shown for simplicity) to generate channel estimates for demodulating portions of the PUSCH used by the UEs 404A-404B for DMRS transmissions. The channel estimates can also be used to determine beamforming matrices at base station 402 for transmitting DL data to the UEs 404A-404B (e.g., on the PDSCH) and for receiving UL data from the UEs 404A-404B (e.g., on the PUSCH).

In various aspects, base station 402 can group UEs within its coverage area into multiple spatial groups, and then configure time-frequency transmission resources for each of the multiple spatial groups. The base station 402 groups the UEs into multiple spatial groups based on respective angle-of-arrival (AoA) information of the respective UEs. In some instances, the base station 402 may group UEs having the same or similar AoA information into the same spatial groups, for example, to provide spatial diversity between the spatial groups of UEs. In other instances, the base station 402 may group UEs having dissimilar AoA information into the same spatial groups, for example, to provide spatial diversity between the UEs within each spatial group. In the example of FIG. 4, the base station 402 groups the first UE 404A and one or more other first UEs (not shown for simplicity) into a first spatial group, and groups the second UE 404B and one or more other second UEs (not shown for simplicity) into a second spatial group.

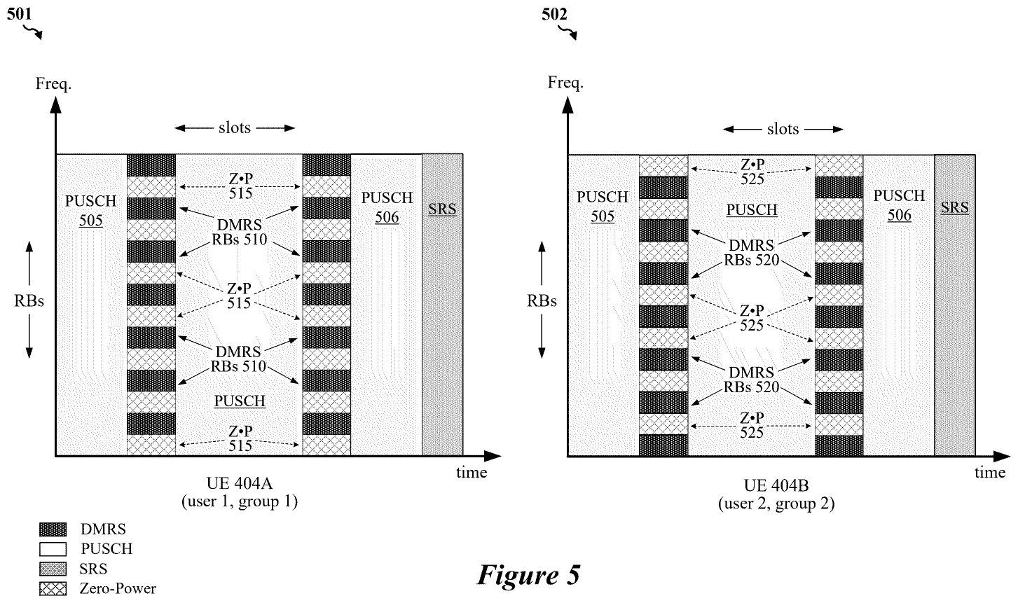

The base station 402 configures the wireless devices in each spatial group to use overlapping time-frequency transmission resources for UL data transmissions to the base station 402. In the example of FIG. 4, the base station 402 configures the first UE 404A and the other first UEs in the first spatial group to use overlapping time-frequency resources for DMRS transmissions, and configures the second UE 404B and the other second UEs in the second spatial group to use overlapping time-frequency resources for DMRS transmissions. The base station 402 then schedules DMRS transmissions by the UEs in the first spatial group on a first set of time-frequency transmission resources, and schedules DMRS transmissions by the UEs in the second spatial group on a second set of time-frequency transmission resources that are different than the first set of time-frequency transmission resources. In some instances, the base station 402 schedules DMRS transmissions from UEs of the first spatial group based on the example UL resource allocation 501 depicted in FIG. 5, and schedules DMRS transmissions from UEs of the second spatial group based on the example UL resource allocation 502 depicted in FIG. 5.

The base station 402 transmits a DCI signal to the first and second spatial groups of UEs on the PDSCH to inform the UEs within its coverage area of the DRMS scheduling information. In some instances, the DCA signal has a pre-defined format indicative of the UL resource allocations 501 and 502 for DMRS transmissions. For example, in some aspects, the DCI signal has a DCI format_0_1, which also configures the UEs in the first spatial group to use a first selected antenna port configuration for DMRS transmissions and configures the UEs in the second spatial group to use a second selected antenna port configuration for DMRS transmissions. In this way, each of the UEs in the first spatial group uses the same antenna ports as the other UEs in the first spatial group for the DMRS transmissions, and each of the UEs in the second spatial group uses the same antenna ports as the other UEs in the second spatial group for the DMRS transmissions. Also, the UEs in the first spatial group use a different antenna port configuration than the UEs in the second spatial group for DMRS transmissions, for example, to maintain orthogonality between DMRS transmissions from the different spatial groups.

The first UE 404A and the other first UEs of the first spatial group decode the DCI signal, obtain the resource allocation indicated by the DCI format, and transmit their respective DMRS on the first time-frequency resources allocated by base station 402. Similarly, the second UE 404B and the other second UEs of the second spatial group decode the DCI signal, obtain the resource allocation indicated by the DCI format, and transmit their respective DMRS on the second time-frequency resources allocated by base station 402. In instances for which the base station 402 operates in an LTE RAN, the base station 402 configures the UEs of the first spatial group to use more than 8 transmission layers and configures the UEs of the second spatial group to use more than 8 transmission layers. In some aspects, base station 402 can configure the UEs in the first and second spatial groups to use up to M different values of cyclic shifts for the DMRS transmissions and to use up to N uplink transmission layers for the DMRS transmissions, where N and M are positive integers and N is greater than M.

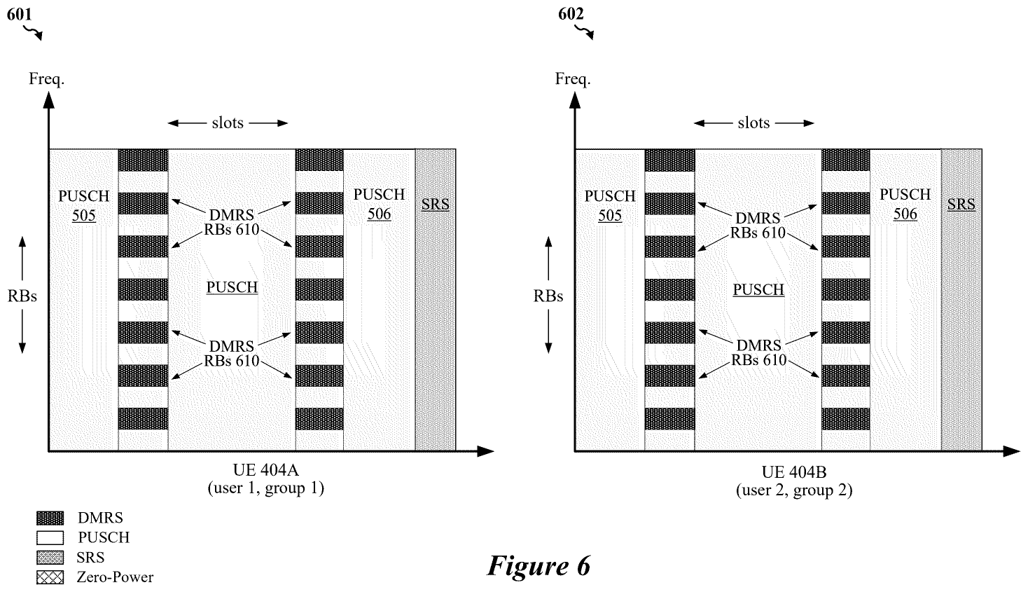

In other implementations, base station 402 can configure all of the UEs in the first spatial group to apply the same cyclic shift to DMRS transmissions when there is more than one transmission layer available, and can configure all of the UEs in the second spatial group to apply the same cyclic shift to DMRS transmissions when there is more than one transmission layer available. In this way, DMRS transmissions from UEs belonging to the same spatial group are not orthogonal to one another but are orthogonal to the UEs belonging to other spatial groups. This approach can be used when the base station 402 employs beamforming at its receiver to provide spatial diversity between DMRS transmissions received from multiple UEs that belong to the same spatial group, for example, as discussed with respect to FIG. 6.

In instances for which the base station 402 operates in a 5G NR access network, the base station 402 can schedule the transmission of DMRS configuration type-1 frames for the UEs in the first and second spatial groups when the number of UL layers available in the base station's coverage area is greater than 6 and less than 12, and can schedule the transmission of DMRS configuration type-2 frames for the UEs in the first and second spatial groups when the number of UL layers available in the base station's coverage area is greater than 12.

In some implementations, base station 402 can ensure that all time-frequency resources not allocated to the first UE 404A for DMRS transmissions are not allocated to other UEs in the first spatial group for DMRS transmissions, and can ensure that all time-frequency resources not allocated to the second UE 404B for DMRS transmissions are not allocated to other UEs in the second spatial group for DMRS transmissions.

In other implementations, base station 402 can apply beamforming at its receiver to allow for the creation of close-to orthogonal beams such that the UEs in the first spatial group are spatially separated from each other and the UEs in the second spatial group are spatially separated from each other. Some beamforming techniques are disclosed in patent publication WO 2021/062354 entitled “MULTI-LAYER MULTI-BEAM COMMUNICATION SYSTEMS,” which is incorporated herein by reference in its entirety. In this case, there is almost no cross interference between the DMRS transmissions associated with different UEs and different spatial groups of UEs. By using the same DMRS resources for all users, aspects of the present disclosure may eliminate the need to reserve zero-power resources and avoid limitations on the maximum number of DMRS allowed. As such, in some aspects, base station 402 can avoid scheduling zero-power transmissions on the sets of time-frequency resources allocated to the first and second spatial groups for DMRS transmissions or can refrain from allocating zero-power time-frequency resources on the sets of time-frequency resources allocated to the first and second spatial groups for DMRS transmissions.

The base station 402 receives the DMRS transmissions from UEs in each of the first and second spatial groups, and thereafter can use the received DMRS to demodulate UL data (and other information on the PUSCH) transmitted by the UEs in each of the first and second spatial groups.

FIG. 5 shows example UL resource allocations 501 and 502, according to some implementations. The example UL resource allocations 501 and 502 are depicted as a function of time (or slots or OFDM symbols) indicated along the horizontal axis and frequency (or RBs or subcarriers) indicated along the vertical axis. In the example of FIG. 5, each of the UL resource allocations 501 and 502 shows a DMRS transmission pattern located between PUSCH allocations 505 and 506 that can be used for DMRS (and other UL data) transmissions to base station 402. Specifically, the DMRS transmission pattern of the UL resource allocation 501 indicates a number of first RBs 510 allocated to the first UE 404A and the other first UEs in the first spatial group for DMRS transmissions, and also indicates a number Z⋅P RBs 515 designated for zero-power transmissions by the UEs of the first spatial group. Similarly, the DMRS transmission pattern of the UL resource allocation 502 indicates a number of second RBs 520 allocated to the second UE 404B and the other second UEs in the second spatial group for DMRS transmissions, and also indicates a number of Z⋅P RBs 525 designated for zero-power transmissions by the UEs of the second spatial group.

As shown, the first UE 404A and the other first UEs in the first spatial group are allocated or otherwise assigned to DMRS time-frequency resources 510 that are orthogonal to the DMRS time-frequency resources 520 allocated to the second UE 404B and the other second UEs in the second spatial group. As such, in some instances, UEs belonging to the first spatial group can transmit DMRS on even-numbered RBs spanning one or more OFDM symbols or subframes, and UEs belonging to the second spatial group can transmit DMRS on odd-numbered RBs spanning one or more OFDM symbols or subframes. In some aspects, the DMRS time-frequency resources 510 and the DMRS time-frequency resources 520 may be non-overlapping frequency resources.

FIG. 6 shows example UL resource allocations 601 and 602 on which DMRS transmissions from respective UEs 404A and 404B can be received with beamforming applied by base station 402, with time (or slots and OFDM symbols) indicated along the horizontal axis and frequency (or RBs and subcarriers) indicated along the vertical axis. As shown, the first UE 404A and other UEs of the first spatial group are allocated or otherwise assigned the same time-frequency resources as the second UE 404B and the other UEs of the second spatial group for DMRS transmissions. That is, the same RBs 610 located between adjacent PUSCH allocations 505 and 506 can be used by UEs 404A and 404B, as well as the UEs belonging to each of the first and second spatial groups, without zero-power transmission constraints. As such, the example UL resource allocations 601 and 602 do not include any zero-power transmission RBs or zero-power transmission resource allocations.

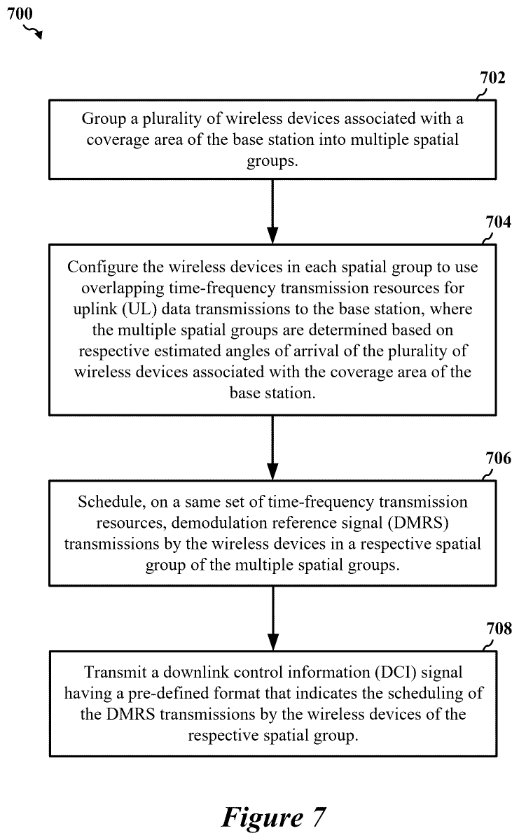

FIG. 7 shows a flowchart depicting an example operation 700 for wireless communication. The operation 700 may be performed by a base station such as the base station 102 of FIG. 1, the base station 310 of FIG. 3, or the base station 402 of FIG. 4. In some implementations, the base station discussed with respect to the example operation 700 may be associated with a fifth-generation new radio (5G NR) RAN. In some instances, the base station may schedule the transmission of DMRS configuration type-1 frames on UL channels associated with the RAN when the number of UL transmission layers available in the base station's coverage area is greater than 6, and the base station may schedule the transmission of DMRS configuration type-2 frames on the UL channels when the number of available UL transmission layers is greater than 12.

At 702, the base station groups a plurality of wireless devices associated with a coverage area of the base station into multiple spatial groups. At 704, the base station configures the wireless devices in each spatial group to use overlapping time-frequency transmission resources for uplink (UL) data transmissions to the base station, where the multiple spatial groups are determined based on respective estimated angles of arrival of the plurality of wireless devices associated with the coverage area of the base station. At 706, the base station schedules, on the same set of time-frequency transmission resources, demodulation reference signal (DMRS) transmissions by the wireless devices in a respective spatial group of the multiple spatial groups. In some aspects, each of the wireless devices in the respective spatial group uses the same antenna ports as the other wireless devices in the respective spatial group for the DMRS transmissions.

In some instances, the operation 700 continues at 708 with the base station transmitting a downlink control information (DCI) signal having a pre-defined format that indicates the scheduling of the DMRS transmissions by the wireless devices of the respective spatial group. In some aspects, the pre-defined format of the DCI signal is DCI format_0_1, and the wireless devices in the respective spatial group are configured with the same antenna ports value. In some instances, scheduling the DMRS transmissions may include avoiding scheduling zero-power transmissions on the same set of time-frequency resources. In other instances, scheduling the DMRS transmissions may include ensuring that all time-frequency resources not allocated for DMRS transmissions from one wireless device in the respective spatial group are not allocated for DMRS transmissions from the other wireless devices in the respective spatial group. In some other instances, scheduling the DMRS transmissions may include not allocating zero-power time-frequency resources for wireless devices in the respective spatial group.

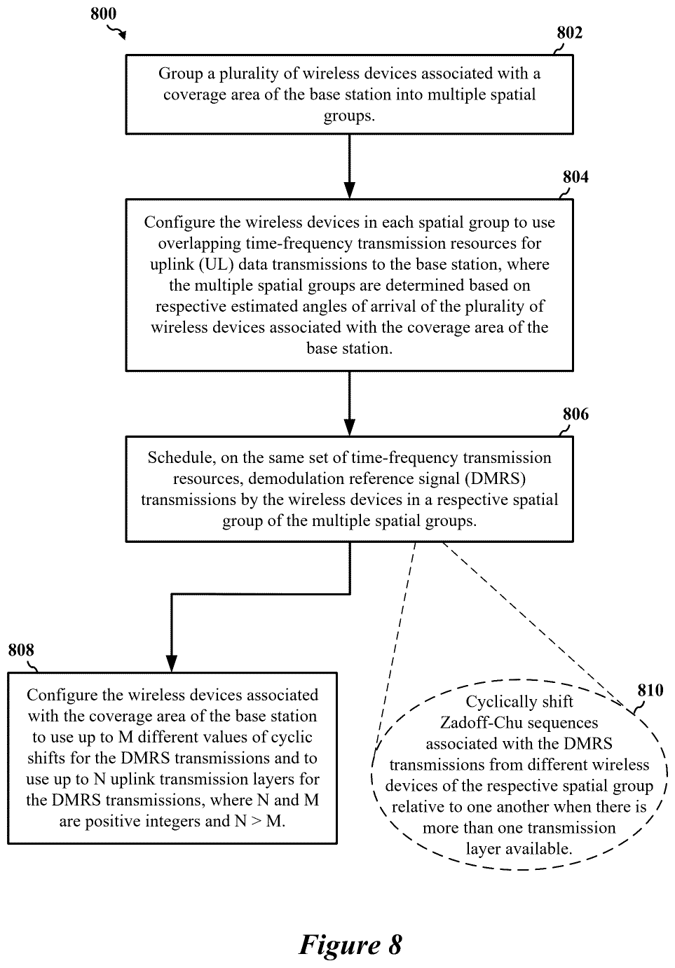

FIG. 8 shows a flowchart depicting another example operation 800 for wireless communication. The operation 800 may be performed by a base station such as the base station 102 of FIG. 1, the base station 310 of FIG. 3, or the base station 402 of FIG. 4. In some implementations, the base station discussed with respect to the example operation 800 may be associated with a Long-Term Evolution (LTE) RAN. In some instances, the base station configures wireless devices associated with the coverage area to use more than 8 transmission layers per spatial group.

At 802, the base station groups a plurality of wireless devices associated with a coverage area of the base station into multiple spatial groups. At 804, the base station configures the wireless devices in each spatial group to use overlapping time-frequency transmission resources for uplink (UL) data transmissions to the base station, where the multiple spatial groups are determined based on respective estimated angles of arrival of the plurality of wireless devices associated with the coverage area of the base station. At 806, the base station schedules, on the same set of time-frequency transmission resources, demodulation reference signal (DMRS) transmissions by the wireless devices in a respective spatial group of the multiple spatial groups. In various implementations, the base station schedules the DMRS transmissions by cyclically shifting Zadoff-Chu sequences associated with the DMRS transmissions from different wireless devices of the respective spatial group relative to one another when there is more than one transmission layer available. In some aspects, each of the wireless devices in the respective spatial group uses the same antenna ports as the other wireless devices in the respective spatial group for the DMRS transmissions.

In some instances, the operation 800 continues at 808 with the base station configuring the wireless devices associated with the coverage area of the base station to use up to M different values of cyclic shifts for the DMRS transmissions and to use up to N uplink transmission layers for the DMRS transmissions, where N and M are positive integers and N is greater than M.

It will be appreciated that various aspects of the subject matter disclosed herein can be used for re-using DMRS transmission resources by exploiting spatial diversity. Specifically, various enhancements to existing 5G and LTE reference signal transmission schemes disclosed herein may allow for more a more efficient use of transmission resources associated with their respective radio access networks. In various aspects, a wireless device such as a user equipment (UE) can receive one or more allocations of DMRS transmission resources from a base station, and then send DMRS transmissions over one or more RE's indicated by the one or more allocations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices (such as a combination of a DSP and a microprocessor), a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of wireless communication by a base station associated with a radio access network (RAN), the method comprising:
grouping a plurality of wireless devices associated with a coverage area of the base station into multiple spatial groups;
configuring the wireless devices in each spatial group to use overlapping time-frequency transmission resources for uplink (UL) data transmissions to the base station, wherein the multiple spatial groups are determined based on respective estimated angles of arrival of the plurality of wireless devices associated with the coverage area of the base station; and
scheduling, on a same set of time-frequency transmission resources, demodulation reference signal (DMRS) transmissions by the wireless devices in a respective spatial group of the multiple spatial groups.

2. The method of claim 1, wherein the RAN is a fifth-generation new radio (5G NR) RAN, and the base station schedules the transmission of DMRS configuration type-1 frames when the number of UL layers available in the base station's coverage area is greater than 6.

3. The method of claim 1, wherein the RAN is a fifth-generation new radio (5G NR) RAN, and the base station schedules the transmission of DMRS configuration type-2 frames when the number of UL layers available in the base station's coverage area is greater than 12.

4. The method of claim 1, wherein each of the wireless devices in the respective spatial group uses the same antenna ports as the other wireless devices in the respective spatial group for the DMRS transmissions.

5. The method of claim 1, wherein the scheduling further includes one or both of:
avoiding scheduling zero-power transmissions on the same set of time-frequency resources; and
not allocating zero-power time-frequency resources for wireless devices in the respective spatial group.

6. The method of claim 1, wherein the scheduling further includes:
ensuring that all time-frequency resources not allocated for DMRS transmissions from one wireless device in the respective spatial group are not allocated for DMRS transmissions from the other wireless devices in the respective spatial group.

7. The method of claim 1, further including:
transmitting a downlink control information (DCI) signal having a pre-defined format that indicates the scheduling of the DMRS transmissions by the wireless devices of the respective spatial group.

8. The method of claim 7, wherein the pre-defined format of the DCI signal is DCI format_0_1, and the wireless devices in the respective spatial group are configured with the same antenna ports value.

9. The method of claim 1, wherein the RAN is a Long-Term Evolution (LTE) RAN, and the base station configures wireless devices associated with the coverage area to use more than 8 transmission layers per spatial group.

10. The method of claim 1, wherein the RAN is a Long-Term Evolution (LTE) RAN, the method further including:
configuring the wireless devices associated with the coverage area of the base station to use up to M different values of cyclic shifts for the DMRS transmissions and to use up to N uplink transmission layers for the DMRS transmissions, where N and M are positive integers and N is greater than M.

11. The method of claim 1, wherein the RAN is a Long-Term Evolution (LTE) RAN, and scheduling the DMRS transmissions further includes:
applying the same cyclic shift to DMRS transmissions associated with the wireless devices in the respective spatial group when there is more than one transmission layer available.

12. A base station associated with a radio access network (RAN), comprising:
one or more processors; and
a memory storing instructions that, when executed by the one or more processors, causes the base station to perform operations including:
grouping a plurality of wireless devices associated with a coverage area of the base station into multiple spatial groups;
configuring the wireless devices in each spatial group to use overlapping time-frequency transmission resources for uplink (UL) data transmissions to the base station, wherein the multiple spatial groups are determined based on respective estimated angles of arrival of the plurality of wireless devices associated with the coverage area of the base station; and
scheduling, on a same set of time-frequency transmission resources, demodulation reference signal (DMRS) transmissions by the wireless devices in a respective spatial group of the multiple spatial groups.

13. The base station of claim 12, wherein the RAN is a fifth-generation new radio (5G NR) RAN, and the base station schedules the transmission of DMRS configuration type-1 frames when the number of UL layers available in the base station's coverage area is greater than 6.

14. The base station of claim 12, wherein the RAN is a fifth-generation new radio (5G NR) RAN, and the base station schedules the transmission of DMRS configuration type-2 frames when the number of UL layers available in the base station's coverage area is greater than 12.

15. The base station of claim 12, wherein each of the wireless devices in the respective spatial group uses the same antenna ports as the other wireless devices in the respective spatial group for the DMRS transmissions.

16. The base station of claim 12, wherein execution of the instructions for the scheduling further includes one or both of:
avoiding scheduling zero-power transmissions on the same set of time-frequency resources; and
not allocating zero-power time-frequency resources for wireless devices in the respective spatial group.

17. The base station of claim 12, wherein execution of the instructions for the scheduling further includes:
ensuring that all time-frequency resources not allocated for DMRS transmissions from one wireless device in the respective spatial group are not allocated for DMRS transmissions from the other wireless devices in the respective spatial group.

18. The base station of claim 12, wherein execution of the instructions causes the base station to perform operations further including:
transmitting a downlink control information (DCI) signal having a pre-defined format that indicates the scheduling of the DMRS transmissions by the wireless devices of the respective spatial group.

19. The base station of claim 18, wherein the pre-defined format of the DCI signal is DCI format_0_1, and the wireless devices in the respective spatial group are configured with the same antenna ports value.

20. The base station of claim 12, wherein the RAN is a Long-Term Evolution (LTE) RAN, and the base station configures wireless devices associated with the coverage area to use more than 8 transmission layers per spatial group.

21. The base station of claim 12, wherein the RAN is a Long-Term Evolution (LTE) RAN, and execution of the instructions causes the base station to perform operations further including:
configuring the wireless devices associated with the coverage area of the base station to use up to M different values of cyclic shifts for the DMRS transmissions and to use up to N uplink transmission layers for the DMRS transmissions, where N and M are positive integers and N is greater than M.

22. The base station of claim 12, wherein the RAN is a Long-Term Evolution (LTE) RAN, and execution of the instructions for scheduling the DMRS transmissions further includes:
applying the same cyclic shift to DMRS transmissions associated with the wireless devices in the respective spatial group when there is more than one transmission layer available.
